(19) United States
(12) Patent Application Publication
(10) Pub. No.: US 2019/0322456 A1
(43) Pub. Date: Oct. 24, 2019

(54) CARRIAGE ASSEMBLY FOR A TRANSPORT SYSTEM

(71) Applicant: Regal Beloit America, Inc., Beloit, WI (US)

(72) Inventors: Christopher Edwin Eugene Propp, Wausau, WI (US); Michael A. Logsdon, Wausau, WI (US); Laura Michelle Reamer, Wausau, WI (US); James P. Johnson, Valparaiso, IN (US); Simon Andrew Odland, Aberdeen, SD (US); Larry Gene Anderson, Aberdeen, SD (US); Christopher Andrew Carrigan, Brooksville, KY (US); Nathan Daniel Gruber, Wausau, WI (US)

(21) Appl. No.: 16/464,993

(22) PCT Filed: Nov. 17, 2017
(86) PCT No.: PCT/US2017/062227

§ 371 Date: May 29, 2019

Related U.S. Application Data
(60) Provisional application No. 62/487,597, filed on Apr. 20, 2017.
(60) Provisional application No. 62/427,642, filed on Nov. 29, 2016.

(51) Int. Cl. B65G 17/32; B65G 47/61

(52) U.S. Cl. CPC B65G 17/323; B65G 47/61

(57) ABSTRACT

A carriage assembly for a transport system includes a first body and a second body configured to moveably couple to a beam defining a transport path. The carriage assembly also includes a carrier coupled to the first body and the second body. The carrier is configured to support a container such that the carriage assembly transports the container along the transport path. The carriage assembly further includes a drive system coupled to at least one of the first body and the second body. The drive system is configured to move the carriage assembly along the transport path.

### CROSS-REFERENCE TO RELATED APPLICATION

This application claims priority to both U.S. Provisional Patent Application Nos. 62/427,642 filed 29 Nov. 2016 and 62/487,597 filed 20 Apr. 2017, the entire disclosures of which is hereby incorporated by reference in its entirety.

### BACKGROUND

The field of the disclosure relates generally to transport systems, and more specifically to a transport system including a carriage assembly configured to transport a container along a track.

In at least some known transport systems, containers are loaded onto vehicles and moved between transfer locations. At some transfer locations, the containers are placed onto and/or removed from long-haul vehicles and/or sea vessels. In at least some known transport systems, the containers are handled by operators and/or operator-controlled machines at the transfer locations. Each time a container is handled by operators and/or operator-controlled machines is counted as a “contact point.” The efficiency of a transport system is at least partially determined by the number of contact points and the length of time containers spend at transfer locations. However, the vehicles used for at least some known transport systems cause congestion and increase the number of contact points. In addition, the vehicles are prone to breaking down, which further reduces the efficiency of the transport systems.

At least some known transport systems include automated systems such as cranes, lifts, and robots. However, such automated systems are limited by the current technology. For example, at least some known automated systems only transport containers over short distances. In addition, at least some known automated systems require multiple contact points to pick up, transport, and place a container.

### BRIEF DESCRIPTION

In one aspect, a carriage assembly for a transport system is provided. The transport system includes a beam defining a transport path. The carriage assembly includes a first body and a second body configured to moveably couple to the beam. The carriage assembly also includes a carrier coupled to the first body and the second body. The carrier is configured to support a container such that the carriage assembly transports the container along the transport path. The carriage assembly further includes a drive system coupled to at least one of the first body and the second body. The drive system is configured to move the carriage assembly along the transport path.

In another aspect, a transport system is provided. The transport system includes at least one beam defining a transport path and at least one carriage assembly coupled to the at least one beam and movable along the transport path. The at least one carriage assembly includes a carrier configured to support a container such that the carriage assembly transports the container along the transport path. The at least one carriage assembly also includes a first body and a second body coupled to the carrier. The at least one carriage assembly further includes a drive system coupled to at least one of the first body and the second body to move the at least one carriage assembly relative to the at least one beam.

In one aspect, a carriage assembly for a transport system is provided. The transport system includes a beam defining a transport path. The carriage assembly includes at least one body configured to moveably couple to the beam. The at least one body defines a length of the carriage assembly. The carriage assembly also includes a drive system coupled to the at least one body. The drive system is configured to move the carriage assembly along the transport path. The transport system further includes a display coupled to a side of the carriage assembly such that the display is visible from an exterior of the carriage assembly. The display is configured to display a first image at a first location along the transport path and a second image at a second location along the transport path. The display extends along the length of the carriage assembly parallel to the beam.

In another aspect, a transport system is provided. The transport system includes at least one beam defining a transport path. The transport system also includes at least one carriage assembly coupled to the at least one beam and movable along the transport path. The at least one carriage assembly includes a display coupled to a side of the carriage assembly such that the display is visible from an exterior of the carriage assembly. The display is configured to display an image. The display extends along the carriage assembly parallel to the beam. The transport system further includes a controller configured to determine a position of the at least one carriage assembly along the transport path and select the image based on the position.

In yet another aspect, a method of displaying information along a transport path of a transport system is provided. The method includes moving at least one carriage assembly along a beam defining the transport path. The transport system includes a communication system that defines a communication zone. The at least one carriage assembly includes a communication component configured to receive a signal within the communication zone. The method also includes displaying a first image on a display coupled to the at least one carriage assembly such that the first image is visible from an exterior of the at least one carriage assembly. The method further includes sending a signal to the at least one carriage assembly within the communication zone. The signal relates to a second image. The method further includes displaying the second image on the display such that the second image is visible from the exterior of the at least one carriage assembly.

### BRIEF DESCRIPTION OF THE DRAWINGS

FIG. 1 is a schematic plan view of an exemplary transport system;

FIG. 2 is a perspective view of a portion of the transport system shown in FIG. 1 including a carriage assembly;

FIG. 3 is a front view of the carriage assembly shown in FIG. 2;

FIG. 4 is a side view of the carriage assembly shown in FIG. 2;

FIG. 5 is a perspective view of a body of the carriage assembly shown in FIG. 2;

FIG. 6 is a side view of a body of the carriage assembly shown in FIG. 2;

FIG. 7 is a perspective view of an isolation member of the carriage assembly shown in FIG. 2;

FIG. 8 is a partial sectional view of a portion of the carriage assembly shown in FIG. 2 including a carrier in a locked position;

FIG. 9 is a partial sectional view of a portion of the carriage assembly shown in FIG. 2 including a carrier in an unlocked position;

FIG. 10 is a schematic of the carriage assembly shown in FIG. 2 moving relative to a container;

FIG. 11 is a schematic of the carriage assembly shown in FIG. 2 coupling to the container shown in FIG. 10;

FIG. 12 is a schematic perspective view of the carriage assembly shown in FIG. 2 detecting a position of the container shown in FIG. 10;

FIG. 13 is a schematic perspective view of an alternative embodiment of a carriage assembly detecting a position of the container shown in FIG. 10;

FIG. 14 is a perspective view of a pair of the carriage assemblies shown in FIG. 2;

FIG. 15 is a schematic of one embodiment of a conveyor system for use with the transport system shown in FIG. 1;

FIG. 16 is a perspective view of a portion of transport system shown in FIG. 1 including displays and the carriage assembly shown in FIG. 2; and

FIG. 17 is a front view of the carriage assembly and displays shown in FIG. 16.

### DETAILED DESCRIPTION

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

Embodiments described herein provide a transport system including a carriage assembly that is suspended from and travels along an overhead track. The carriage assembly includes a plurality of modular bodies coupled together. The modular bodies are coupled to the track such that the carriage assembly moves along the track. For example, in some embodiments, each body is substantially U-shaped and is coupled to the track by a pair of wheels extending from legs of the U-shaped body on opposite sides of the track. At least one drive system is coupled to the bodies and is configured to propel the carriage assembly along the track. In addition, the bodies are coupled to a carrier by at least one isolation member configured to allow independent movement of the bodies. The carrier is configured to couple to and support a load, such as a container. A locking device extends between the carrier and the body and allows the carrier to pivot when the carrier is loaded and inhibits the carrier pivoting when the carrier is unloaded. In some embodiments, the carriage assembly includes at least one sensor to determine a position of the carriage assembly relative to the container and/or other carriage assemblies. Also, in some embodiments, the transport system includes a tiered network system with localized high-speed zones to allow efficient transmission of data between the carriage assemblies and a controller. In further embodiments, the transport system includes a conveyor system that positions the containers for pick up by the carriage assembly. Accordingly, the embodiments described herein increase the efficiency of transport systems. For example, embodiments described herein reduce congestion and contact points in comparison to known transport systems. In addition, embodiments described herein require less resources to assemble and operate.

Embodiments described herein provide a transport system including a carriage assembly that is suspended from and travels along an overhead track. The carriage assembly includes a plurality of modular bodies and at least one display coupled to the modular bodies. The modular bodies are coupled to the track such that the carriage assembly moves along the track. The display is configured to display different images as the carriage assembly moves along the track. For example, in some embodiments, the display is configured to display a first image within a first zone and a second image within a second zone. In some embodiments, the images relate to a commercial advertisement and/or an operational status. Accordingly, the display allows the operators to generate revenue by displaying commercial advertisements along the track. In addition, the display allows the operator to display service information as the carriage assembly moves through services zones. Accordingly, the display is configured to provide increased revenue and facilitate servicing and/or operating the transport system.

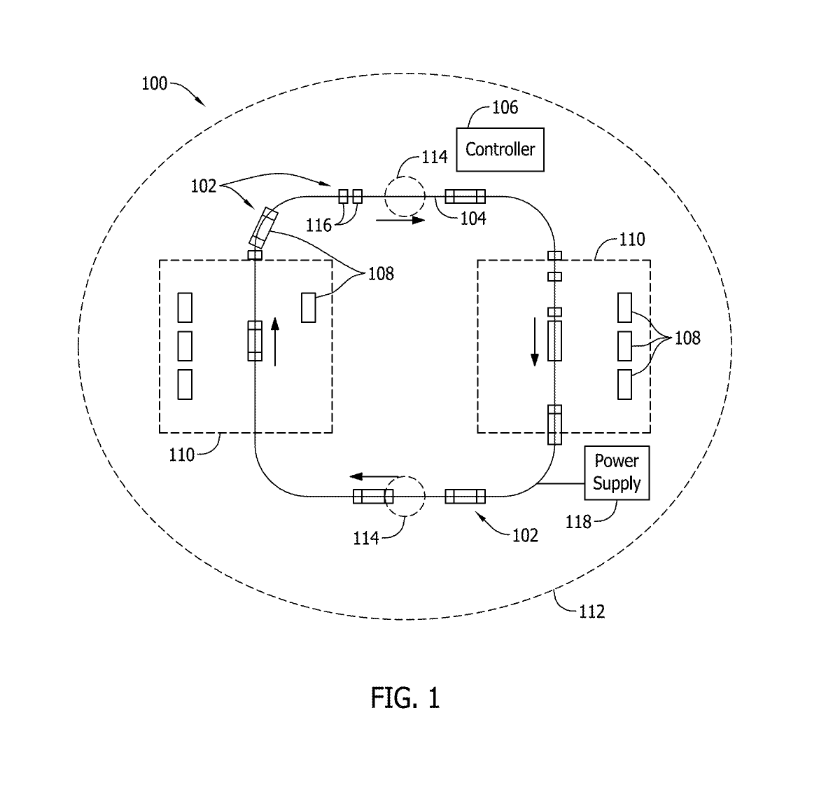

FIG. 1 is a schematic plan view of an exemplary transport system 100. Transport system 100 includes a plurality of carriage assemblies 102, a beam, more broadly a track, 104, and a controller 106. Beam 104 defines a transport path. Carriage assemblies 102 are configured to couple to beam 104 and move along the transport path. In addition, carriage assemblies 102 are configured to transport containers, more broadly loads, 108 along the transport path. In alternative embodiments, carriage assemblies 102 are configured to move any load along any transport path that enables transport system 100 to operate as described herein. For example, in some embodiments, the transport path has multiple branches and/or loops. In further embodiments, carriage assemblies 102 are configured to move along more than one transport path.

In addition, in the exemplary embodiment, carriage assemblies 102 are configured to pick up and/or place containers 108 within transfer areas 110. In some embodiments, containers 108 are placed onto and/or removed from long-haul transport vehicles or vessels, such as trucks, trains, and ships. For example, in some embodiments, at least one transfer area 110 includes a docking station for ships. In such embodiments, transport system 100 transports containers 108 for placement on the long-haul transport vessels and/or receives containers 108 removed from the long-haul transport vessels. In further embodiments, transfer area 110 includes a storage area. In alternative embodiments, transport system 100 includes any transfer area 110 that enables transport system 100 to operate as described herein. For example, in some embodiments, carriage assemblies 102 are configured to transport passengers and transfer areas 110 include passenger boarding and/or deboarding stations.

Also, in the exemplary embodiment, each container 108 is coupled to and transported by a plurality of carriage assemblies 102. In particular, a first carriage assembly 102 is configured to couple to a first end of container 108 and a second carriage assembly 102 is configured to couple to a second end of container 108. Accordingly, each container 108 is carried by two or more carriage assemblies 102. In alternative embodiments, container 108 is carried by any carriage assembly 102 that enables transport system 100 to operate as described herein.

In the exemplary embodiment, controller 106 controls each carriage assembly 102 individually as each carriage assembly 102 moves along beam 104. For example, controller 106 sends signals to carriage assembly 102 to control a speed and direction of carriage assembly 102 during operation of carriage assembly 102. Accordingly, transport system 100 is at least partially automated. In some embodiments, carriage assemblies 102 are moved in pairs and each pair of carriage assemblies 102 is configured to transport a single container 108 at a time. Carriage assemblies 102 are spaced varying distances apart. For example, in some embodiments, paired carriage assemblies 102 are closely spaced when unloaded and are spaced farther apart when coupled to a container 108. Each carriage assembly 102 is modular and is replaceable if carriage assembly 102 requires maintenance and/or is removed from service. For example, in some embodiments, when a carriage assembly 102 is removed from service, a replacement carriage assembly 102 is coupled to beam 104 and sent towards the mate of the out-of-service carriage assembly 102. In alternative embodiments, carriage assemblies 102 move along beam 104 in any manner that enables transport system 100 to operate as described. For example, in some embodiments, single carriage assemblies 102 are queued and moved into position individually when required.

In the exemplary embodiment, controller 106 includes a processor and a memory device. Accordingly, controller 106 is configured to execute a program for controlling carriage assembly 102. In addition, controller 106 is configured to store information relating to operation of transport system 100. In other embodiments, transport system 100 includes any controller 106 that enables transport system 100 to operate as described herein.

In addition, in the exemplary embodiment, transport system 100 includes a tiered communication network that defines a first communication zone 112 and a second communication zone 114. Each carriage assembly 102 includes a communication component 116 that is configured to send and receive data within first communication zone 112 and second communication zone 114. Communication component 116 is configured to communicate wirelessly with controller 106. In first communication zone 112, communication component 116 is able to send data at a first rate. First communication zone 112 encompasses substantially the entire transport system 100. Accordingly, each carriage assembly 102 is able to send data at any point along the transport path, which facilitates controller 106 controlling movement of carriage assemblies 102 along the transport path. In contrast, second communication zone 114 includes one or more discrete areas where carriage assembly 102 is able to send data at a second rate. The second rate is faster than the first rate, which facilitates carriage assembly 102 sending relatively large amounts of lower priority data, i.e., data dumping. In some embodiments, carriage assembly 102 is configured to store at least some data as carriage assembly 102 moves along beam 104 and transmit the data to controller 106 when carriage assembly 102 passes through second communication zone 114. In alternative embodiments, transport system 100 includes any communication zone that enables transport system 100 to operate as described herein. In some embodiments, carriage assemblies 102 are configured to communicate with controller 106 through a wired connection.

Also, in the exemplary embodiment, first communication zone 112 enables data transfer at a rate in a range of about 10 kilobytes per second to about 100 kilobytes per second. In addition, first communication zone 112 has a range up to about 100 miles. In alternative embodiments, first communication zone 112 utilizes any signal that enables transport system 100 to operate as described herein.

In addition, in the exemplary embodiment, second communication zone 114 enables data transfer at a rate in a range of about 10 kilobytes per second to about 1,000 megabytes per second. In addition, second communication zone 114 has a range up to about 100 meters. In alternative embodiments, second communication zone 114 utilizes any signal that enables transport system 100 to operate as described herein.

During operation, in the exemplary embodiment, controller 106 is able to communicate with carriage assembly 102 throughout the transport path because first communication zone 112 encompasses the entire transport path. Accordingly, first communication zone 112 facilitates control and troubleshooting of carriage assemblies 102 during travel of carriage assemblies 102 along the transport path. When carriage assembly 102 is within second communication zone 114, carriage assembly 102 transmits data, such as sensor data collected during transit of a loop of the transport path. Accordingly, second communication zone 114 facilitates carriage assembly 102 and controller 106 tracking raw data, such as maintenance and performance records, usage data, tracking data, times, speeds, loads, and any other data. In alternative embodiments, transport system 100 includes any communication system that enables transport system 100 to operate as described. For example, in some embodiments, at least some components of transport system 100 communicate through wired connections.

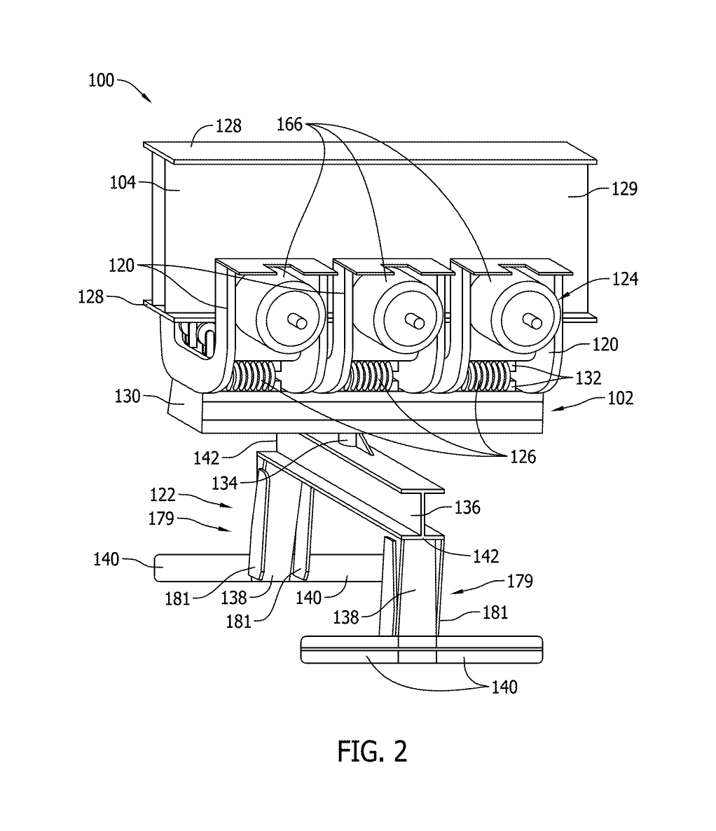

Also, in the exemplary embodiment, transport system 100 includes a power supply 118. Power supply 118 is coupled to beam 104 and is configured to provide power to carriage assemblies 102 during operation of transport system 100. For example, in some embodiments, power supply 118 is coupled to a cable that extends along beam 104. Carriage assemblies 102 are at least partially powered by electrical power flowing through the cable. In some embodiments, power supply 118 includes one or more generators that generate electrical power. In some embodiments, motors 166 (shown in FIG. 2) of carriage assemblies 102 utilize regenerative braking to provide power to a power supply bus. In alternative embodiments, transport system 100 includes any power supply 118 that enables transport system 100 to operate as described herein.

FIG. 2 is a perspective view of a portion of transport system 100 including carriage assembly 102. Carriage assembly 102 couples to and moves along beam 104. In the exemplary embodiment, beam 104 is supported a distance above the ground, i.e., beam 104 forms an overhead track. Carriage assembly 102 is configured to couple to beam 104 such that carriage assembly 102 is suspended from beam 104. Carriage assembly 102 is positioned underneath beam 104 in reference to the orientation shown in FIG. 2. Beam 104 is an I-beam and includes flanges 128 and a web 129 extending between flanges 128. In alternative embodiments, transport system 100 includes any track that enables transport system 100 to operate as described herein.

In reference to FIG. 2, carriage assembly 102 has a segmented shape formed by a plurality of bodies 120 coupled together. In the exemplary embodiment, each carriage assembly 102 includes three bodies 120. Bodies 120 move relative to each other to facilitate carriage assembly 102 moving along beam. For example, bodies 120 move relative to each other as carriage assembly 102 moves along turns and inclines of beam 104. In alternative embodiments, transport system 100 includes any carriage assembly 102 that enables transport system 100 to operate as described herein.

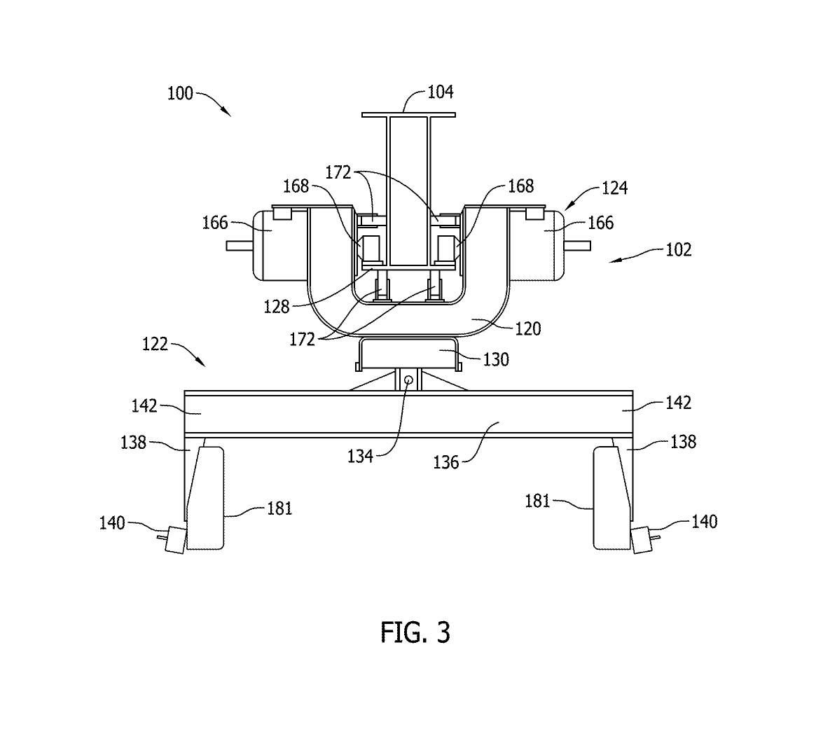

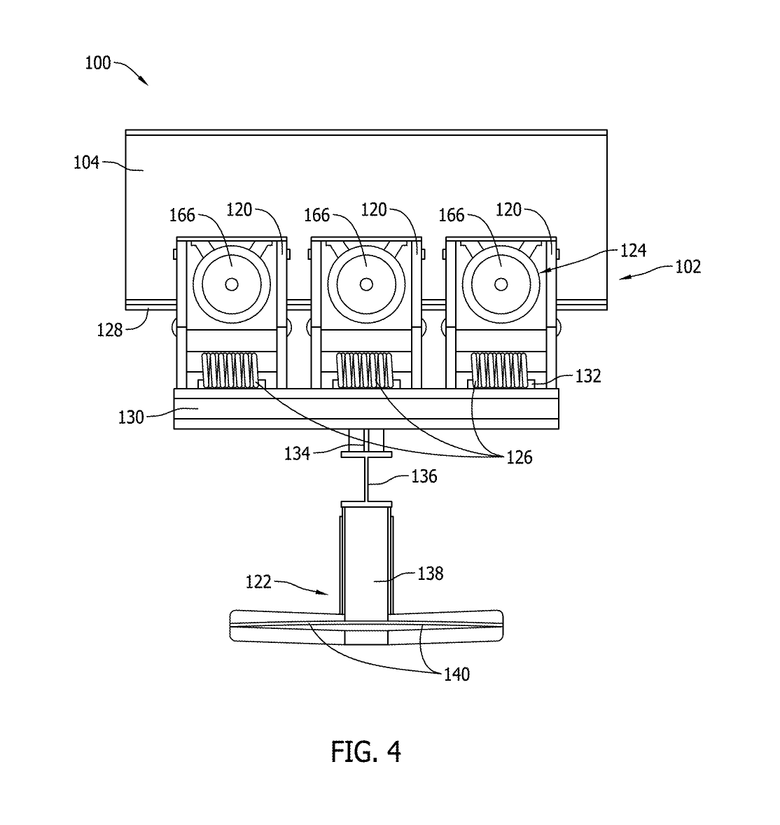

FIG. 3 is a front view of carriage assembly 102. FIG. 4 is a side view of carriage assembly 102. Carriage assembly 102 includes at least one body 120, a carrier 122, a drive system 124, and at least one isolation member 126. Also, in the exemplary embodiment, a spreader 130 couples bodies 120 to each other and to carrier 122. In addition, spreader 130 distributes a load from carrier 122 substantially evenly to bodies 120. Spreader 130 is configured to extend along beam 104 in the direction of motion of carriage assembly 102. Spreader 130 is substantially channel shaped and defines an interior space to house components such as communication component 116 (shown in FIG. 1). Rails 132 extend from a surface of spreader 130 opposite bodies 120 and are configured to receive isolation members 126. Bodies 120 are spaced apart along spreader 130. In alternative embodiments, carriage assembly 102 includes any spreader 130 that enables carriage assembly 102 to operate as described herein.

In the exemplary embodiment, carrier 122 includes a neck 134, a cross member 136, legs 138, and feet 140. Neck 134 extends from cross member 136 intermediate ends 142 of cross member 136. Neck 134 is configured to couple to spreader 130 as described below. Cross member 136 is an I-beam having flanges and a web. Legs 138 extend from opposite ends 142 of cross member 136 in a direction away from neck 134. Feet 140 extend from legs 138 adjacent distal ends of legs 138. Feet 140 are angled to facilitate feet 140 securing to container 108 (shown in FIG. 1). For example, during operation, feet 140 support handles on container 108 and couple carrier 122 to container 108. Carriage assembly 102 includes a sensor 179 to detect a position of carriage assembly 102 relative to container 108 and/or another carriage assembly 102. In addition, sensor 179 includes a plurality of one-way flaps 181 positioned on opposite sides of carrier 122 to facilitate proper alignment of carriage assembly 102 and container 108. In alternative embodiments, carriage assembly 102 includes any carrier 122 that enables carriage assembly 102 to operate as described herein.

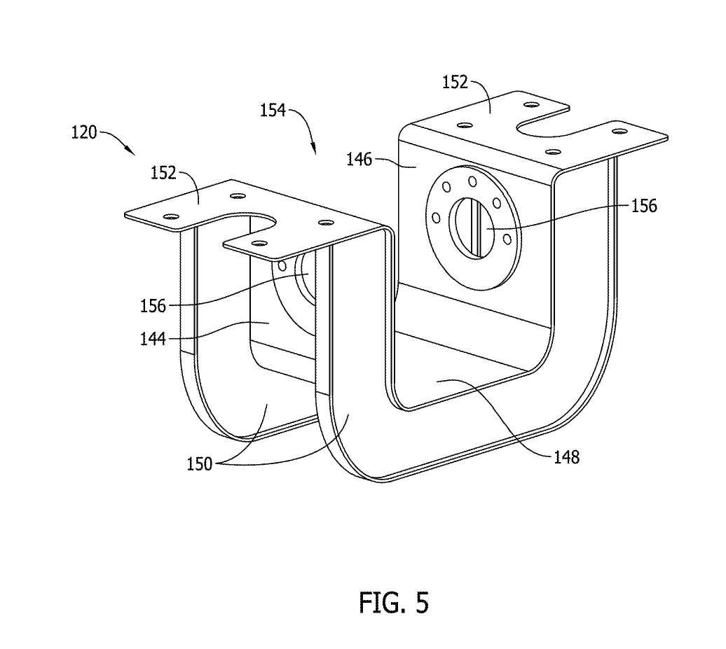

FIG. 5 is a perspective view of a body 120 of carriage assembly 102. Body 120 is modular and reduces the resources required to assemble and maintain carriage assembly 102. In addition, body 120 is substantially U-shaped. Each body 120 includes a first leg 144, a second leg 146, and a base 148 extending between first leg 144 and second leg 146. In addition, body 120 includes flanges 150 and brackets 152. Flanges 150 extend along edges of first leg 144, second leg 146, and base 148 on opposite ends of body 120. Brackets 152 extend from distal ends of first leg 144 and second leg 146. First leg 144, second leg 146, and base 148 define a cavity 154 configured to receive beam 104 (shown in FIG. 2). In addition, each of first leg 144 and second leg 146 define openings 156. Body 120 facilitates carriage assembly 102 (shown in FIG. 2) coupling to beam 104 (shown in FIG. 2). In alternative embodiments, body 120 has any configuration that enables carriage assembly 102 (shown in FIG. 1) to operate as described herein.

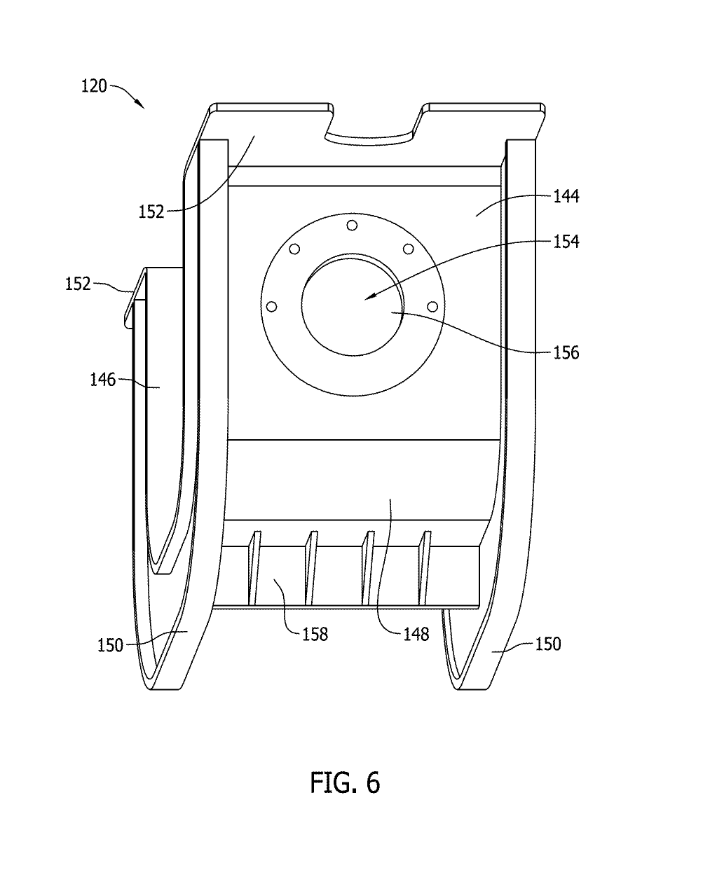

FIG. 6 is a side view of body 120 of carriage assembly 102 (shown in FIG. 2). Each body 120 further includes a ridge 158 extending between flanges 150. Ridge 158 provides support to body 120 and is configured to engage neck 134 of carrier 122. In particular, ridge 158 forms a detent or catch that engages carrier 122 and inhibits movement of carrier 122 when carrier 122 is engaged with ridge 158. Each ridge 158 of bodies 120 does not necessarily engage carrier 122. In the exemplary embodiment, only ridge 158 of middle body 120 is positioned adjacent carrier 122 and is configured to engage carrier 122. In alternative embodiments, body 120 includes any ridge 158 that enables carriage assembly 102 (shown in FIG. 2) to operate as described herein. In further embodiments, ridge 158 is omitted.

In reference to FIG. 2, each body 120 is coupled to spreader 130 by at least one isolation member 126. In particular, a set of two isolation members 126 extends between and couples each body 120 to spreader 130. Isolation members 126 allow each body 120 to move independently of other bodies 120. In other words, bodies 120 have freedom of movement relative to each other, which facilitates movement of carriage assembly 102 along the transport path. In addition, the configuration of bodies 120 and isolation members 126 reduce squealing during movement of carriage assembly 102. Moreover, isolation members 126 allow bodies 120 to move relative to carrier 122 and relative to a load carried by carrier 122, e.g., container 108. Accordingly, carriage assembly 102 is able to make relatively tight turns and travel along a transport path designed with multiple constraints on shape and size. In alternative embodiments, bodies 120 are coupled to each other, spreader 130, and/or carrier 122 in any manner that enables carriage assembly 102 to operate as described herein.

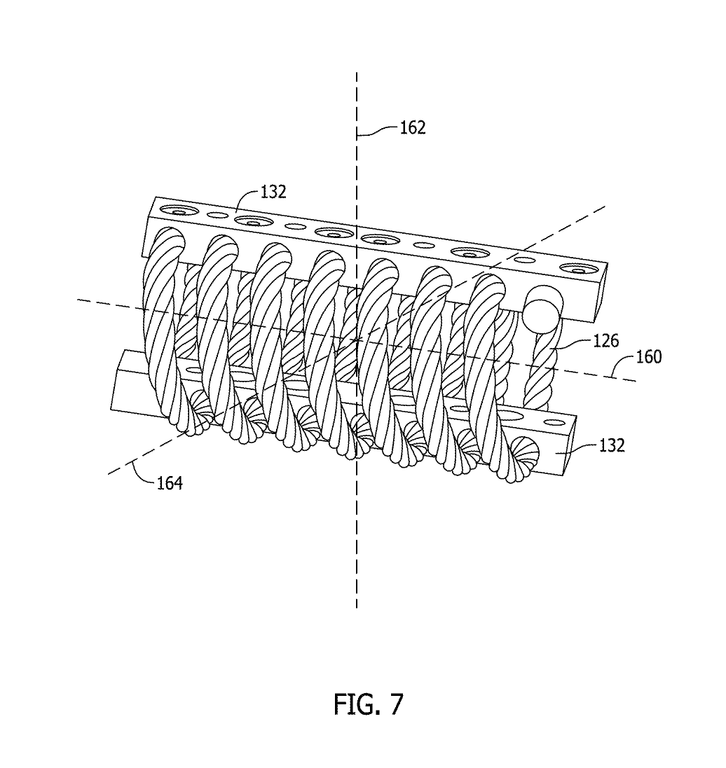

FIG. 7 is a perspective view of isolation member 126 of carriage assembly 102. Isolation member 126 acts in compression and tension to provide freedom of movement of bodies 120 relative to each other and relative to carrier 122. In addition, isolation member 126 dampens shocks during movement of carriage assembly 102. Also, isolation member 126 acts as a suspension system and distributes a load from carrier 122 among wheels 168 coupled to bodies 120. In the exemplary embodiment, isolation member 126 includes a coiled spring constructed from stainless steel. Isolation member 126 extends through openings in rails 132 coupled to bodies 120 (shown in FIG. 2) and spreader 130 (shown in FIG. 2). In particular, isolation member 126 extends alternatingly through openings in rails 132 such that isolation member 126 has a helical configuration. The helical configuration of isolation member 126 facilitates isolation member 126 moving in multiple directions. In addition, isolation members 126 provide redundant coupling of carrier 122 (shown in FIG. 2) to bodies 120 and increase the safety factors of transport system 100 (shown in FIG. 1). In alternative embodiments, carriage assembly 102 includes any isolation member 126 that enables carriage assembly 102 to operate as described herein.

In the exemplary embodiment, isolation member 126 defines at least three axes of movement. In particular, isolation member 126 defines a first axis 160, a second axis 162, and a third axis 164. First axis 160 extends substantially in the direction of movement of carriage assembly 102 (shown in FIG. 2). First axis 160, second axis 162, and third axis 164 are perpendicular with respect to each other. Isolation member 126 acts in compression and tension along each of first axis 160, second axis 162, and third axis 164. Accordingly, isolation member 126 allows each body 120 (shown in FIG. 2) to move in at least six directions relative to each other and relative to carrier 122 (shown in FIG. 2). In alternative embodiments, isolation member 126 allows movement in any direction that enables carriage assembly 102 (shown in FIG. 2) to operate as described herein.

Also, in the exemplary embodiment, isolation member 126 biases rails 132 to a neutral position relative to first axis 160, second axis 162, and third axis 164. Accordingly, bodies 120 (shown in FIG. 2) and carrier 122 (shown in FIG. 2) coupled to rails 132 are biased to the neutral positions. In a neutral position, rails 132 are spaced apart a desired distance along second axis 162. In addition, in the neutral position, rails 132 are aligned relative to first axis 160 and third axis 164. Isolation member 126 is elastic and allows displacement of rails 132 when a force greater than the biasing force of isolation member 126 acts on rails 132. Isolation member 126 biases rails 132 towards the neutral position when rails 132 are displaced. During operation, rails 132 are displaced from the neutral position when carrier 122 (shown in FIG. 2) is coupled to container 108 (shown in FIG. 1) and/or when carriage assembly 102 (shown in FIG. 2) moves along beam 104 (shown in FIG. 2). In alternative embodiments, isolation member 126 provides any bias force that enables carriage assembly 102 (shown in FIG. 2) to operate as described herein.

In reference to FIG. 2, drive system 124 includes at least one motor 166 and is configured to move carriage assembly 102 along beam 104. In the exemplary embodiment, drive system 124 includes six motors 166. Each motor 166 is positioned adjacent one of first leg 144 and second leg 146 of bodies 120. In particular, motors 166 are coupled to brackets 152 and disposed adjacent openings 156. In alternative embodiments, carriage assembly 102 includes any motor 166 that enables carriage assembly 102 to operate as described herein.

In addition, in the exemplary embodiment, drive system 124 includes wheels 168 that are configured to contact flange 128 of beam 104. Each motor 166 is drivingly coupled to wheel 168 by a drive shaft 170 that extends into cavity 154 through openings 156. Motors 166 induce rotation of drive shaft 170 and drive shaft 170 rotates wheels 168 that move carriage assembly 102 along beam 104 during operation of carriage assembly 102. Each motor 166 is coupled to a single wheel 168 that enables independent motion of wheels 168 and facilitates movement of carriage assembly 102 along curves and slopes. Wheels 168 and bodies 120 are configured to allow removal of carriage assembly 102 from beam 104 without disassembly of carriage assembly 102. In particular, wheels 168 are substantially smaller than a depth of beam 104 to allow manipulation of bodies 120 and carriage assembly 102 relative to beam 104. In addition, wheels 168 are removable. Wheels 168 have diameter that is smaller than a diameter of opening 156 to facilitate removal and/or attachment of wheels 168, drive shaft 170, and/or motor 166. In alternative embodiments, carriage assembly 102 includes any drive system 124 that enables carriage assembly 102 to operate as described herein. For example, in some embodiments, drive system 124 includes a gearbox (not shown).

In addition, in the exemplary embodiment, carriage assembly 102 includes guide wheels 172. Guide wheels 172 extend from body 120 and contact beam 104. Specifically, guide wheels 172 extend from each of first leg 144, second leg 146, and base 148 into cavity 154. Guide wheels 172 are configured to guide carriage assembly 102 along beam 104 and are not necessarily driven by a motor. In alternative embodiments, carriage assembly 102 includes any wheel that enables carriage assembly 102 to operate as described herein.

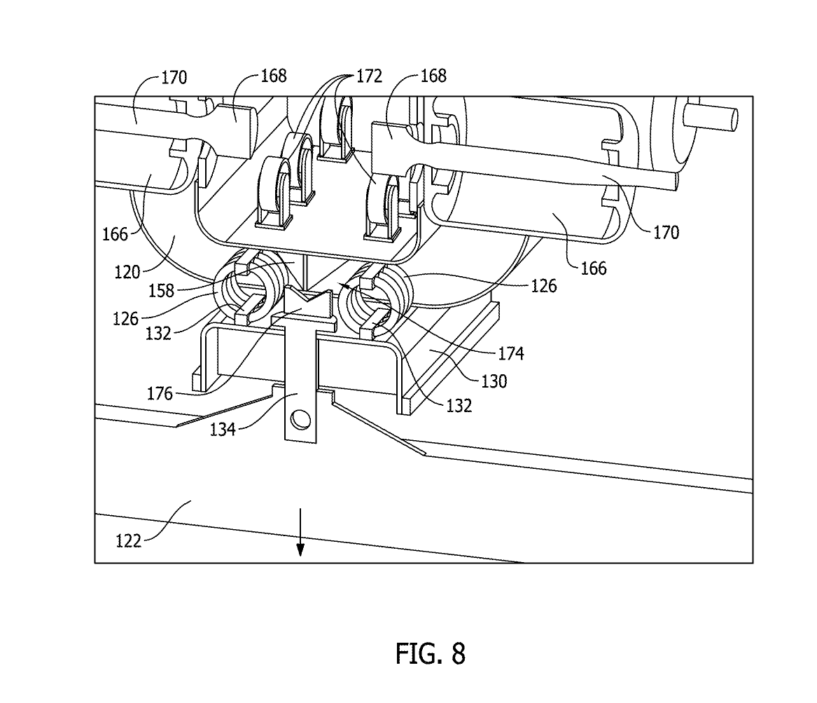

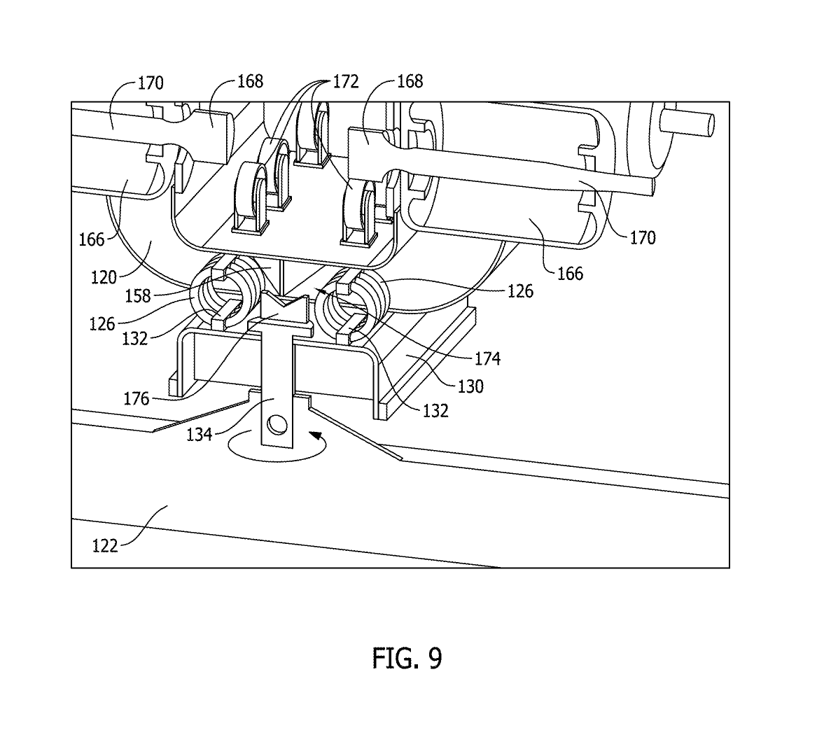

FIG. 8 is a partial sectional view of a portion of carriage assembly 102 including carrier 122 in a locked position. FIG. 9 is a partial sectional view of a portion of carriage assembly 102 including carrier 122 in an unlocked position. Carrier 122 is coupled to spreader 130 and positionable between the locked position and the unlocked position. In particular, neck 134 extends through an opening in spreader 130. A head 176 extends from neck 134 and contacts spreader 130 to inhibit removal of carrier 122 from spreader 130. Head 176 also engages ridge 158 of body 120 when carrier 122 is in the locked position. In some embodiments, head 176 has a spherical convex shape and engages a mating spherical concave mounting surface of spreader 130. Accordingly, head 176 and spreader 130 facilitate freedom of movement of carrier 122 relative to spreader 130 in at least three directions. For example, carrier 122 rotates about a longitudinal axis of neck 134 and pivots or swivels relative to spreader 130 and body 120. The freedom of movement of carrier 122 facilitates container 108 (shown in FIG. 1) moving during transport, such as on inclines, declines, and turns. In particular, carrier 122 facilitates movement of container 108 (shown in FIG. 1) when carriage assemblies 102 coupled to container 108 are located at different elevations. Neck 134 and head 176 facilitates alignment and near equal load sharing amongst bodies 120. In alternative embodiments, carrier 122 is coupled to body 120 in any manner that enables carriage assembly 102 to operate as described herein.

In the exemplary embodiment, carrier 122 is allowed to rotate or pivot relative to body 120 when carrier 122 is in the unlocked position. Carrier 122 is inhibited from moving relative to body 120 when carrier 122 is in the locked position. In particular, a locking device 174 engages at least one of body 120 and carrier 122.

Locking device 174 inhibits movement of carrier 122 when carrier 122 is in the locked position. In the exemplary embodiment, locking device 174 includes a ridge 158 which forms a detent or catch. Ridge 158 extends from body 120 and contacts a portion of carrier 122 to inhibit rotation of carrier 122 when carrier 122 is in the locked position. Isolation members 126 bias spreader 130 and carrier 122 towards bodies 120, i.e., bias carrier 122 towards the locked position. Carrier 122 moves from the locked position to the unlocked position when spreader 130 and carrier 122 are moved away from bodies 120. For example, carrier 122 moves to the unlocked position when carrier 122 is coupled to a load that at least partially overcomes the bias of isolation members 126. When the load moves carrier 122 into the unlocked position, carrier 122 is allowed to rotate relative to body 120. The unlocked position of carrier 122 facilitates carriage assembly 102 transporting the load along the transport path. The locked position of carrier 122 facilitates carrier 122 coupling to the load. In alternative embodiments, carriage assembly 102 includes any locking device 174 that enables carriage assembly 102 to operate as described herein.

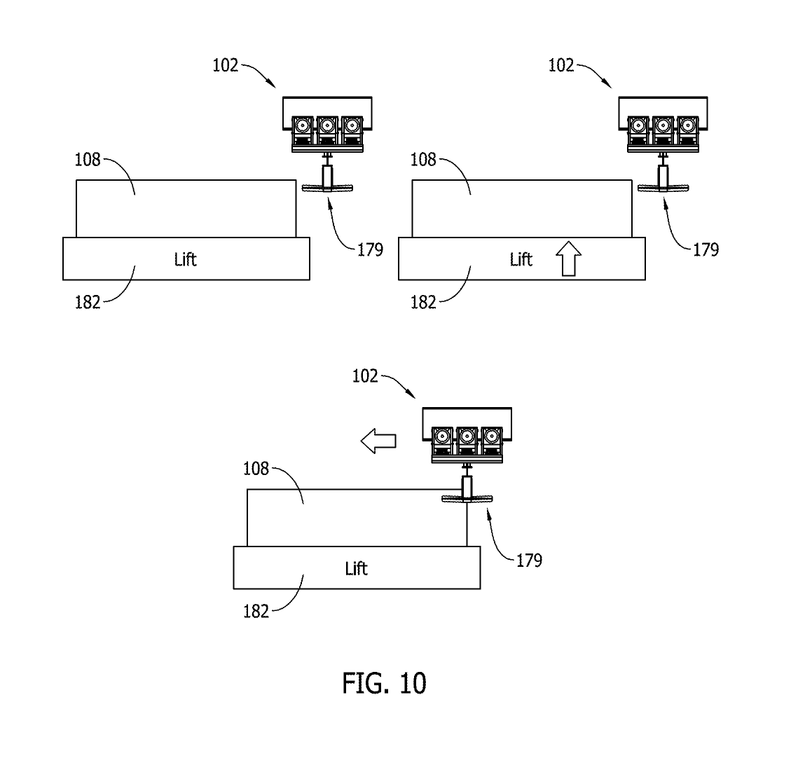

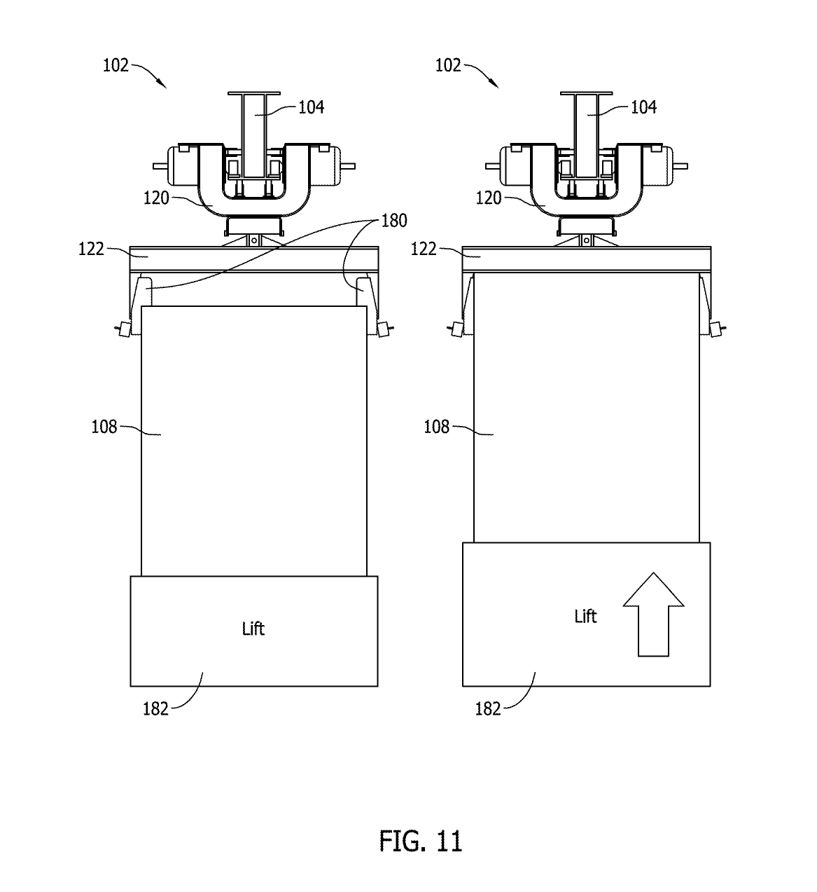

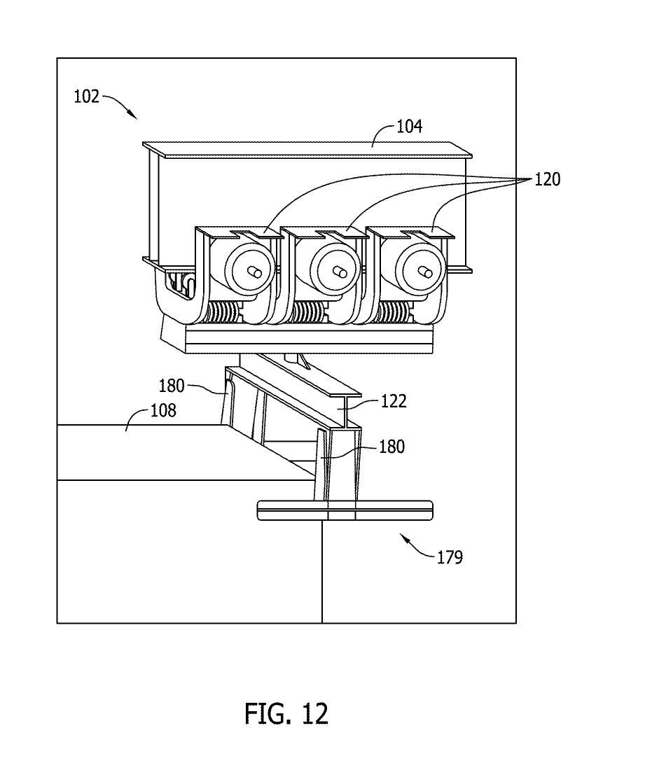

FIG. 10 is a schematic of carriage assembly 102 moving relative to container 108. FIG. 11 is a schematic of carriage assembly 102 coupling to container 108. FIG. 12 is a schematic perspective view of carriage assembly 102 detecting a position of container 108. Carriage assembly 102 includes a sensor 179 to detect a position of carriage assembly 102 relative to container 108 and/or another carriage assembly 102. Specifically, sensor 179 is configured to detect an end of container 108 and determine a position of carriage assembly 102 relative to container 108. In alternative embodiments, carriage assembly 102 includes any sensor 179 that enables carriage assembly 102 to operate as described herein. For example, in some embodiments, carriage assembly 102 includes, without limitation, at least one sensor of the following: a visual sensor, an inductive sensor, an acoustic sensor, and a mechanical sensor. In further embodiments, sensor 179 is omitted and carriage assembly 102 is positioned relative to container 108 based on the spacing between carriage assemblies 102 and/or a position of carriage assembly 102 along beam 104.

In the exemplary embodiment, sensor 179 includes a plurality of one-way flaps 180 positioned on opposite sides of carrier 122. Flaps 180 contact container 108 as carriage assembly 102 is moved towards container 108. Flaps 180 are displaced by container 108 and facilitate proper alignment of carriage assembly 102 and container 108. In some embodiments, information from sensor 179 and operational data such as motor current, motor revolutions per minute, and/or operating time are used to determine positions of carriage assembly 102.

During operation, sensor 179 detects container 108 as carriage assembly 102 is moved towards container 108. At least one of sensor 179 and controller 106 (shown in FIG. 1) determines a position of carriage assembly 102 relative to container 108. Carrier 122 is maintained in the locked position as carriage assembly 102 is positioned relative to container 108. Accordingly, carrier 122 is inhibited from rotating relative to body 120 and container 108 prior to carrier 122 coupling to container 108. When carriage assembly 102 is adjacent container 108, carriage assembly 102 stops at a desired position relative to container 108. Container 108 is then raised by a lift 182 and coupled to carrier 122. In some embodiments, carriage assemblies 102 are simultaneously coupled to opposite ends of container 108. When at least one carriage assembly 102 is coupled to container 108, container 108 is removed from lift 182 and transported along beam 104. When carriage assembly 102 is coupled to container 108, carrier 122 is moved to the unlocked position to allow carrier 122 and container 108 to rotate relative to bodies 120 during transportation of carriage assembly 102. In alternative embodiments, container 108 is coupled to carriage assembly 102 in any manner that enables transport system 100 (shown in FIG. 1) to operate as described herein. For example, in some embodiments, carriage assembly 102 couples to container 108 without lift 182 raising container 108.

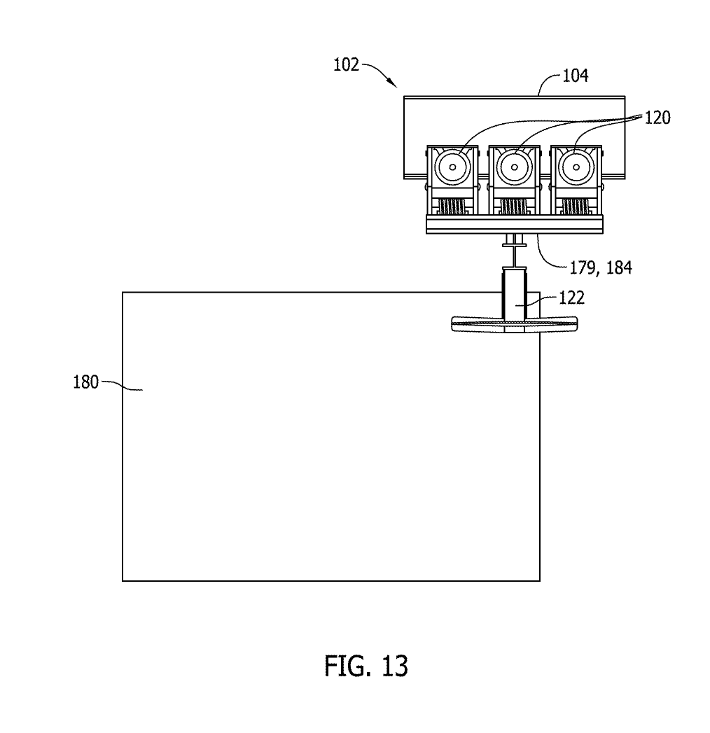

FIG. 13 is a schematic side view of an embodiment of carriage assembly 102 detecting a position of container 108. In the exemplary embodiment, sensor 179 of carriage assembly 102 includes a noncontact sensor 184. Noncontact sensor 184 is configured to detect container 108 and facilitate determining a position of carriage assembly 102 relative to container 108. During operation, noncontact sensor 184 detects an end of container 108 when container 108 enters a field of view of noncontact sensor 184. Carriage assembly 102 is positioned relative to container 108 based at least in part on information from noncontact sensor 184. In some embodiments, noncontact sensor 184 includes, for example and without limitation, a visual sensor, an inductive sensor, an acoustic sensor, and any other sensor that enables carriage assembly 102 to operate as described herein.

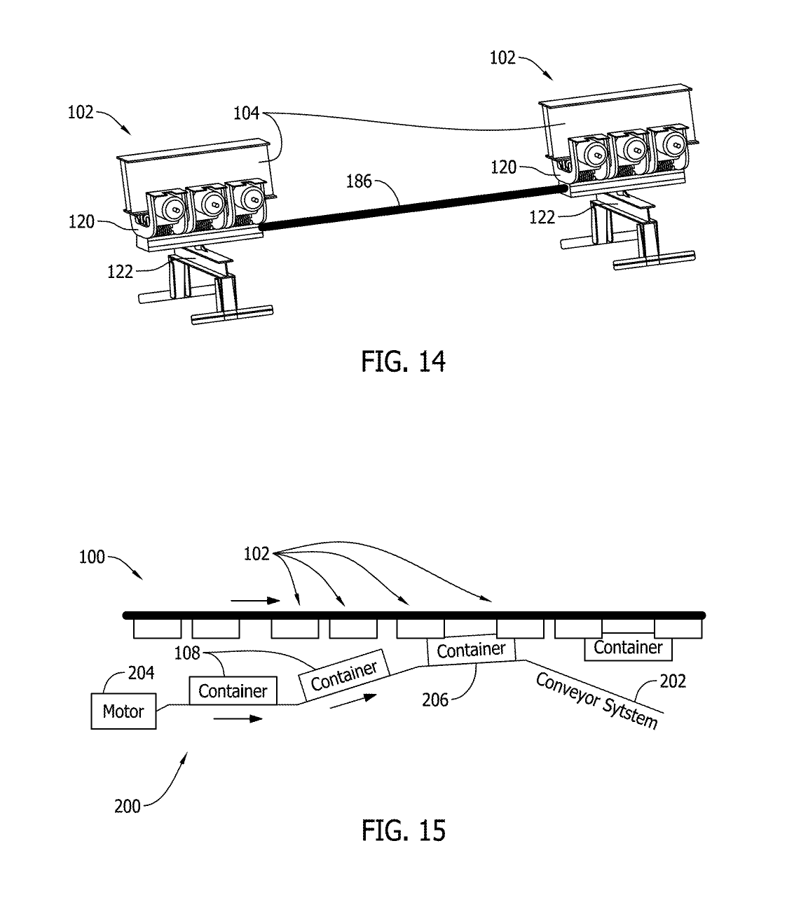

FIG. 14 is a perspective view of a pair of carriage assemblies 102. Carriage assemblies 102 are coupled together by a cable 186 and are configured to couple to the same container 108 (shown in FIG. 1). In particular, a first carriage assembly 102 couples to a first end of container 108 (shown in FIG. 1) and a second carriage assembly 102 couples to a second end of container 108 (shown in FIG. 1). First carriage assembly 102 and second carriage assembly 102 are maintained at a desired spacing by cable 186 to facilitate carriage assemblies 102 coupling to opposite ends of container 108 (shown in FIG. 1). Cable 186 provides a mechanical measurement of the distance between carriage assemblies 102. In addition, cable 186 is selectively retractable to adjust the spacing between carriage assemblies 102 and facilitate carriage assemblies 102 coupling to different size containers 108 (shown in FIG. 1). In some embodiments, cable 186 increases the reliability and accuracy of the spacing between carriage assemblies 102. For example, cable 186 is not substantially affected by the environment and weather. In alternative embodiments, carriage assemblies 102 are spaced apart in any manner that enables transport system 100 (shown in FIG. 1) to operate as described herein. For example, in some embodiments, controller 106 (shown in FIG. 1) determines positions of carriage assemblies 102 along beam 104 and controls carriage assemblies 102 to maintain a desired spacing.

FIG. 15 is a schematic of one embodiment of a conveyor system 200 for use with transport system 100. Conveyor system 200 includes a continuous conveyor belt 202 that transports containers 108. Conveyor belt 202 is driven by a motor 204. Conveyor system 200 extends adjacent transport system 100 and transports containers to a position for coupling to carriage assemblies 102. In particular, conveyor system 200 includes an elevated portion 206 that raises containers 108 to an elevation that is reachable by carriage assemblies 102. In alternative embodiments, conveyor system 200 has any configuration that enables conveyor system 200 to operate as described herein.

During operation, conveyor belt 202 continuously transports containers 108 for coupling to carriage assemblies 102. Containers 108 are moved toward elevated portion 206 where containers 108 are removed from conveyor belt 202 by carriage assemblies 102. In some embodiments, at least some containers 108 are not picked up by transport system 100, such as when the size of container 108 exceeds the capacity of transport system 100. Such containers 108 are carried past transport system 100 to an unloading area where containers 108 are manually removed from conveyor belt 202. Accordingly, conveyor belt 202 and transport system 100 do not substantially alter processes for handling containers 108 that are not transported by transport system 100.

In reference to FIGS. 1 and 2, a method of operating transport system 100 generally includes coupling container 108 to carriage assembly 102 and moving carriage assembly 102 along beam 104. Accordingly, container 108 is transported along the transport path between transfer areas 110. In some embodiments, containers 108 are transferred to and/or from long haul storage vehicles and vessels. Along the transport path, carriage assembly 102 is controlled by controller 106 using first communication zone 112. Carriage assembly 102 sends and receives lower-priority data using second communication zone 114. Carrier 122 is positioned in a locked position prior to carriage assembly 102 coupling to container 108. When carriage assembly 102 is coupled to container 108, carrier 122 is moved into the unlocked position and carrier 122 is allowed to rotate relative to body 120. Accordingly, carrier 122 and container 108 rotate and facilitate movement of carriage assembly 102 along the transport path.

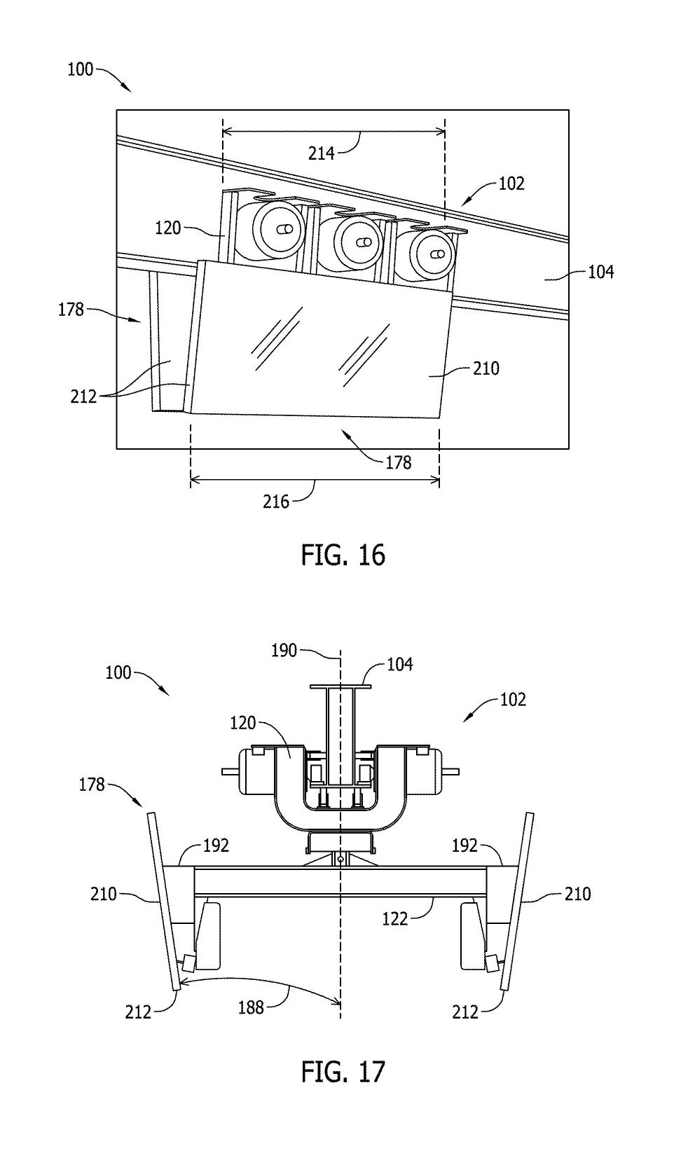

FIG. 16 is a perspective view of a portion of transport system 100 including displays 178 and carriage assembly 102. FIG. 17 is a front view of carriage assembly 102 and displays 178. Displays 178 are configured to provide information to people along the transport path. In the exemplary embodiment, each display 178 includes a screen 210 and a housing 212. Displays 178 are coupled to bodies 120 and/or carrier 122 along opposite exterior sides of carriage assembly 102 such that screens 210 are visible from an exterior of carriage assembly 102. Housings 212 of displays 178 are coupled to carriage assembly 102 using welds, locking features, fasteners, and/or any other suitable attachment component. In alternative embodiments, displays 178 are coupled to any portion of transport system 100 in any manner that enables transport system 100 to operate as described herein. For example, in some embodiments, displays 178 are coupled to a front, a side, and/or a rear of carriage assembly 102. In further embodiments, at least a portion of display 178 and carriage assembly 102 are integrally formed. In some embodiments, each display 178 is coupled to a single body 120.

In the exemplary embodiment, displays 178 are coupled to carrier 122 such that screens 210 extend along a length 214 of carriage assembly 102 in a direction parallel to beam 104 when carriage assembly 102 is coupled to beam 104. Each display 178 is substantially rectangular. Screen 210 of each display 178 includes a substantially planar, rectangular surface. Housing 212 extends along edges of screen 210. Moreover, each screen 210 has a length 216 that is greater than length 214 of carriage assembly 102 such that screens 210 extend beyond ends of carriage assembly 102. As a result, displays 178 provide a larger area for images than is otherwise available on carriage assembly 102. In alternative embodiments, displays 178 have any shape that enables transport system 100 to operate as described herein.

Also, in the exemplary embodiment, displays 178 are positioned such that screens 210 extend at an angle 188 relative to a vertical plane 190 defined through carriage assembly 102 and beam 104. Angle 188 is configured to facilitate viewing displays 178 from locations along the transport path. In some embodiments, angle 188 is in a range of about 5° to about 45°. In alternative embodiments, displays 178 are positioned in any manner that enables transport system 100 to operate as described herein.

In addition, in the exemplary embodiment, each screen 210 is configured to display different images along the transport path. In some embodiments, controller 106 controls the images displayed on screen 210 based on a location of carriage assembly 102 along the track. For example, in some embodiments, each screen 210 displays a first image relating to a commercial advertisement in a first zone and a second image relating to an operational status of carriage assembly 102 in a second zone. In some embodiments, the commercial advertisements are directed toward target audiences along the track. The commercial advertisements allow transport system 100 to generate revenue based on potential views per distance traveled by each carriage assembly 102. In some embodiments, the service messages relate to an operational status of carriage assembly 102 such as a power level, a destination, a load, and/or a service record. In further embodiments, the service messages relate to safety issues. Accordingly, the service messages facilitate servicing and operating transport system 100 and allow transport system 100 to have an increased operational efficiency. In some embodiments, display 178 uses images including text, pictures, and/or symbols. In further embodiments, screens 210 display moving images, i.e., videos. In alternative embodiments, screens 210 display any image that enables carriage assembly 102 to operate as described herein.

Moreover, in the exemplary embodiment, housings 212 are configured to protect screen 210 and electrical components of displays 178. Housings 212 extend along edges of screens 210 and on a rear of displays 178 opposite screens 210screens 210. A mount 192 of housing 212 extends between screen 210 and carriage assembly 102 and is configured to couple displays 178 to carriage assembly 102. In some embodiments, housings 212 include resilient materials such as plastics, metals, and any other material that enables housings 212 to function as described herein. In addition, in some embodiments, housing 212 extends over components of carriage assembly 102 such as drive system 124 and/or electrical components. Accordingly, housing 212 protects components of displays 178 and carriage assembly 102 from the environment. In alternative embodiments, display 178 includes any housing 212 that enables display 178 to operate as described herein.

In reference to FIGS. 1 and 16, in the exemplary embodiment, communication component 116 is configured to receive data relating to the images from controller 106. For example, in some embodiments, controller 106 sends an image to display 178 through communication component 116. In addition, in some embodiments, controller 106 determines a location of carriage assembly 102 and selects the image based on the location. In some embodiments, transport system 100 includes beacons positioned along the track and configured to signal carriage assembly 102 to change images. In further embodiments, controller 106 sends signals to carriage assembly 102 using beacons and/or any other suitable component. In the exemplary embodiment, communication component 116 receives data relating to the images when carriage assembly 102 receives a data dump within second communication zone 114. In alternative embodiments, displays 178 are controlled in any manner that enables transport system 100 to operate as described herein.

Moreover, in the exemplary embodiment, displays 178 are configured to receive power from carriage assembly 102 and/or power supply 118. For example, in some embodiments, displays 178 receive power from power supply 118 through a cable that extends along beam 104 and screens 210 are at least partially powered by the electrical power flowing through the cable. In further embodiments, displays 178 receive at least some power from carriage assemblies 102 and/or an internal power source.

In addition, in reference to FIGS. 1 and 16, a method of displaying information along the transport path of transport system 100 includes moving carriage assembly 102 along beam 104 defining the transport path. In addition, the method includes displaying a first image relating to a commercial advertisement on display 178 coupled to carriage assembly 102 such that the first image is visible from an exterior of carriage assembly 102. In some embodiments, the commercial advertisement is directed towards consumers expected to view the image. For example, in some embodiments, the commercial advertisement is selected based on the demographics of a population of people within an area along the track. The method also includes sending a signal including a second image to carriage assembly 102 within the communication zone. In some embodiments, the second image relates to an operational status of transport system 100 and/or a safety message and is directed towards operators and/or workers within a work area along the track. In addition, the method includes displaying the second image on display 178 such that the second image is visible from an exterior of carriage assembly 102.

The above described embodiments provide a transport system including a carriage assembly that is suspended from and travels along an overhead track. The carriage assembly includes a plurality of modular bodies coupled together. The modular bodies are coupled to the track such that the carriage assembly moves along the track. For example, in some embodiments, each body is substantially U-shaped and is coupled to the track by a pair of wheels extending from legs of the U-shaped body on opposite sides of the track. At least one drive system is coupled to the bodies and is configured to propel the carriage assembly along the track. In addition, the bodies are coupled to a carrier by at least one isolation member configured to allow independent movement of the bodies. The carrier is configured to couple to and support a load, such as a container. A locking device extends between the carrier and the body and allows the carrier to pivot when the carrier is loaded and inhibits the carrier pivoting when the carrier is unloaded. In some embodiments, the carriage assembly includes at least one sensor to determine a position of the carriage assembly relative to the container and/or other carriage assemblies. Also, in some embodiments, the transport system includes a tiered network system with localized high-speed zones to allow efficient transmission of data between the carriage assemblies and a controller. In further embodiments, the transport system includes a conveyor system that positions the containers for pick up by the carriage assembly. Accordingly, the embodiments described herein increase the efficiency of transport systems. For example, embodiments described herein reduce congestion and contact points in comparison to known transport systems. In addition, embodiments described herein require less resources to assemble and operate.

The above described embodiments provide a transport system including a carriage assembly that is suspended from and travels along an overhead track. The carriage assembly includes a plurality of modular bodies and at least one display coupled to the modular bodies. The modular bodies are coupled to the track such that the carriage assembly moves along the track. The display is configured to display different images as the carriage assembly moves along the track. For example, in some embodiments, the display is configured to display a first image within a first zone and a second image within a second zone. In some embodiments, the images relate to a commercial advertisement and/or an operational status. Accordingly, the display allows the operators to generate revenue by displaying commercial advertisements along the track. In addition, the display allows the operator to display service information as the carriage assembly moves through services zones. Accordingly, the display is configured to provide increased revenue and facilitate servicing and/or operating the transport system.

In some embodiments, a carriage assembly includes a first body and a second body configured to moveably couple to a beam defining a transport path. The carriage assembly also includes a carrier coupled to the first body and the second body. The carrier is configured to support a container such that the carriage assembly transports the container along the transport path. The carriage assembly further includes a drive system coupled to at least one of the first body and the second body. The drive system is configured to move the carriage assembly along the transport path.

In further embodiments, a transport system includes at least one beam defining a transport path and at least one carriage assembly coupled to the at least one beam and movable along the transport path. The at least one carriage assembly includes a carrier configured to support a container such that the carriage assembly transports the container along the transport path. The at least one carriage assembly also includes a first body and a second body coupled to the carrier. The at least one carriage assembly further includes a drive system coupled to at least one of the first body and the second body to move the at least one carriage assembly relative to the at least one beam.

In some embodiments, a carriage assembly includes at least one body including a first leg, a second leg, and a base extending between the first leg and the second leg. The first leg and the second leg are spaced apart and define a cavity therebetween. The at least one body is configured to movably couple to a beam defining a transport path such that the beam is received within the cavity. The carriage assembly also includes wheels removably coupled to the at least one body and extending within the cavity to contact the beam.

Also, in some embodiments, a transport system includes a first carriage assembly and a second carriage assembly movably coupled to a beam defining a transport path. The first carriage assembly is configured to couple to a first end of a container and the second carriage assembly is configured to couple to a second end of the container. At least one of the first carriage assembly and the second carriage assembly includes a sensor for determining a position of at least one of the first carriage assembly, the second carriage assembly, and the container.

In addition, in some embodiments, a carriage assembly includes at least one body and a carrier coupled to the at least one body. The carrier is configured to couple to a container. The carrier is positionable between a first position in which the carrier is able to rotate relative to the at least one body and a second position where the carrier is inhibited from rotating relative to the at least one body. The carrier configured to move between the first position and second position when the carrier is coupled to the load.

In further embodiments, a transport system includes a communication system that defines a first communication zone and a second communication zone. The transport system also includes at least one carriage assembly and a controller. The at least one carriage assembly and the controller are configured to communicate wirelessly. The communication system is configured to facilitate the at least one carriage assembly sending data to the controller at a first rate in the first zone and a second rate in the second zone.

In some embodiments, a conveyor system is provided. The conveyor system includes a conveyor belt and a motor configured to move the conveyor belt. The conveyor belt extends adjacent a transport system and moves containers relative to the transport system. The conveyor system is configured to position the containers to couple to a carriage assembly of the transport system. The conveyor system extends from a first transfer area where containers are positioned on the conveyor belt to a second transfer area where containers are removed from the conveyor belt.

In some embodiments, a carriage assembly for a transport system is provided. The transport system includes a beam defining a transport path. The carriage assembly includes at least one body configured to moveably couple to the beam. The at least one body defines a length of the carriage assembly. The carriage assembly also includes a drive system coupled to the at least one body. The drive system is configured to move the carriage assembly along the transport path. The transport system further includes a display coupled to a side of the carriage assembly such that the display is visible from an exterior of the carriage assembly. The display is configured to display a first image at a first location along the transport path and a second image at a second location along the transport path. The display extends along the length of the carriage assembly parallel to the beam.

In further embodiments, a transport system is provided. The transport system includes at least one beam defining a transport path. The transport system also includes at least one carriage assembly coupled to the at least one beam and movable along the transport path. The at least one carriage assembly includes a display coupled to a side of the carriage assembly such that the display is visible from an exterior of the carriage assembly. The display is configured to display an image. The display extends along the carriage assembly parallel to the beam. The transport system further includes a controller configured to determine a position of the at least one carriage assembly along the transport path and select the image based on the position.

An exemplary technical effect of the methods, systems, and apparatus described herein includes at least one of: (a) reducing resources required to assemble and maintain transport systems; (b) reducing contact points of transport systems; (c) reducing congestion of transport systems; (d) increasing reliability of transport systems; (e) reducing downtime of transport systems; (f) providing transport systems with increased design flexibility for different applications; (g) providing commercial advertisements to target audiences along a transport path; (h) providing service messages within a service area of a transport system; (i) reducing downtime of transport systems; (j) providing transport systems with increased communication capabilities; and (k) increasing revenues streams for transports systems.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the terms processor, processing device, and controller.

In the embodiments described herein, memory may include, but is not limited to, a computer-readable medium, such as a random access memory (RAM), and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are examples only, and are thus not limiting as to the types of memory usable for storage of a computer program.

The systems and methods described herein are not limited to the specific embodiments described herein, but rather, components of the systems and/or steps of the methods may be utilized independently and separately from other components and/or steps described herein.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A carriage assembly for a transport system, the transport system including a beam defining a transport path, said carriage assembly comprising:
a first body configured to moveably couple to the beam;
a second body configured to moveably couple to the beam;
a carrier coupled to said first body and said second body, said carrier configured to support a container such that said carriage assembly transports the container along the transport path; and
a drive system coupled to at least one of said first body and said second body, said drive system configured to move said carriage assembly along the transport path.

2. The carriage assembly of claim 1 further comprising at least one isolation member, wherein said at least one isolation member provides freedom of movement of said first body and said second body relative to each other.

3. The carriage assembly of claim 2, wherein said at least one isolation member comprises a first set of isolation members and a second set of isolation members, said first set of isolation members couples said first body to said carrier, said second set of isolation members couples said second body to said carrier.

4. The carriage assembly of claim 2, wherein said at least one isolation member comprises a helical spring.

5. The carriage assembly of claim 1, wherein said first body includes a first leg and a second leg, said second leg and said first leg defining a cavity therebetween to receive the beam.

6. The carriage assembly of claim 5, wherein said drive system includes a motor and at least one wheel drivingly coupled to said motor, said at least one wheel extending into the cavity to contact the beam.

7. The carriage assembly of claim 5, wherein said first leg defines an opening, wherein said drive system is coupled to said first leg, said drive system configured to extend at least partially through the opening in said first leg.

8. The carriage assembly of claim 1, wherein said first body is configured to removably couple to the beam, a first wheel and a second wheel configured to facilitate removal of said first body from the beam without disassembly of said first body.

9. The carriage assembly of claim 1, wherein said carrier is positionable between a locked position and an unlocked position, and wherein said carrier is allowed to pivot relative to said first body when said carrier is in the unlocked position and said carrier is inhibited from pivoting relative to said first body when said carrier is in the locked position.

10. The carriage assembly of claim 9, wherein said carrier is configured to move between the locked position and the unlocked position when a load is coupled to said carrier.

11. The carriage assembly of claim 1 further comprising a sensor to detect a position of said carriage assembly relative to the container.

12. A transport system comprising:
at least one beam defining a transport path; and
at least one carriage assembly coupled to said at least one beam and movable along the transport path, said at least one carriage assembly comprising:
a carrier configured to support a container such that said carriage assembly transports the container along the transport path;
a first body coupled to said carrier;
a second body coupled to said carrier; and
a drive system coupled to at least one of said first body and said second body to move said at least one carriage assembly relative to said at least one beam.

13. The transport system of claim 12 further comprising a communication system that defines a first communication zone and a second communication zone, wherein said at least one carriage assembly is configured to transmit data, said communication system configured to facilitate transmission of data at a first rate in the first communication zone and a second rate in the second communication zone.

14. The transport system of claim 13, wherein the first communication zone encompasses the entire transport path and the second communication zone includes at least one discrete area along the transport path, wherein the second rate is faster than the first rate.

15. The transport system of claim 13 further comprising a conveyor system configured to position the container adjacent the transport path, said at least one carriage assembly configured to couple to the container when the container is positioned adjacent the transport path.

16. The transport system of claim 13, wherein said at least one carriage assembly comprises a first carriage assembly and a second carriage assembly, said first carriage assembly configured to couple to a first end of the container and said second carriage assembly configured to couple to a second end of the container.

17. The transport system of claim 16, wherein said first carriage assembly includes a sensor to detect a position of said first carriage assembly relative to said second carriage assembly.

18. The transport system of claim 13, wherein said at least one carriage assembly includes a sensor to detect a position of said at least one carriage assembly relative to the container.

19. The transport system of claim 18, wherein said sensor comprises at least one sensor of the following: a visual sensor, an inductive sensor, an acoustic sensor, and a mechanical sensor.

20. (canceled)

21. A carriage assembly for a transport system, the transport system including a beam defining a transport path, said carriage assembly comprising:
at least one body configured to moveably couple to the beam, said at least one body defining a length of said carriage assembly;
a drive system coupled to said at least one body, said drive system configured to move said carriage assembly along the transport path; and
a display coupled to a side of said carriage assembly such that said display is visible from an exterior of said carriage assembly, said display configured to display a first image at a first location along the transport path and a second image at a second location along the transport path, wherein said display extends along the length of said carriage assembly parallel to the beam.

22-41. (canceled)
